(19) United States
(12) Patent Application Publication
(10) Pub. No.: US 2026/0227315 A1
(43) Pub. Date: Aug. 6, 2026

(54) DOUBLET ANALYSIS IN FLOW CYTOMETRY

(71) Applicant: Beckman Coulter, Inc., Brea, CA (US)

(72) Inventor: James CATES, Denver, CO (US)

(73) Assignee: Beckman Coulter, Inc., Brea, CA (US)

(21) Appl. No.: 19/150,882

(22) PCT Filed: Jan. 22, 2024
(86) PCT No.: PCT/US2024/012427

§ 371 Date: Jul. 24, 2025

Related U.S. Application Data
(60) Provisional application No. 63/481,298, filed on Jan. 24, 2023.

(51) Int. Cl. G01N 15/1429; G01N 15/14

(52) U.S. Cl. CPC G01N 15/1431; G01N 2015/1402

(57) ABSTRACT

A flow cytometry system for analyzing a fluid stream of particles. The system collects waveform data without thresholding radiated light detected from particles passing through a light beam in an interrogation zone. The system identifies doublets from the waveform data. For each doublet identified from the waveform data, the system separates doublet waveforms into individual waveforms. The system analyzes the individual waveforms separated for each doublet and categorizes the doublets based on the analysis of the individual waveforms.

This application is being filed on Jan. 22, 2024, as a PCT International application and claims the benefit of and priority to U.S. Provisional Patent Application No. 63/481,298 filed on Jan. 24, 2023, the disclosure of which is hereby incorporated by reference in its entirety.

### BACKGROUND

Flow cytometry is a technique for detecting and analyzing chemical and physical characteristics of cells or particles in a fluid sample. For example, a flow cytometer may be used to assess cells from blood, bone marrow, tumors, or other body fluids. Typically, the sample is passed through a fluid nozzle which aligns particles in a single file line within a sheath fluid. A laser beam illuminates the particles as they pass through in single file to generate radiated light including forward scattered light, side scattered light, and fluorescent light. The radiated light can then be detected and analyzed to determine one or more characteristics of the particles.

### SUMMARY

In general terms, the present disclosure relates to analyzing particles using flow cytometry. In one possible configuration, waveform data is collected without thresholding, doublets are identified from the waveform data, and the doublets are separated into separate individual waveforms for analysis. Various aspects are described in this disclosure, which include, but are not limited to, the following aspects.

One aspect relates to a flow cytometry system for analyzing a fluid stream of particles, the flow cytometry system comprising: a light source for emitting a light beam toward an interrogation zone; an optical system including detectors for detecting radiated light from particles passing through the light beam in the interrogation zone; and a processing circuitry having non-transitory computer readable storage media storing instructions which, when executed by the processing circuity, cause the processing circuitry to: collect waveform data without thresholding the radiated light detected from the particles passing through the light beam in the interrogation zone; identify doublets from the waveform data; for each doublet identified from the waveform data, separate doublet waveforms into individual waveforms; perform an analysis of the individual waveforms separated for each doublet; and categorize the doublets based on the analysis of the individual waveforms.

Another aspect relates to a method of analyzing particles flowing through a flow cytometer, the method comprising: collecting waveform data without thresholding radiated light detected from the particles passing through a light beam in an interrogation zone; identifying doublets from the waveform data; for each doublet identified from the waveform data, separating doublet waveforms into individual waveforms; analyzing the individual waveforms separated for each doublet; and categorizing the doublets based on the analysis of the individual waveforms.

Another aspect relates to a non-transitory computer readable medium comprising program instructions, which when executed by a processor, cause the processor to: collect waveform data without thresholding radiated light detected from particles passing through a light beam in an interrogation zone; identify doublets from the waveform data; for each doublet identified from the waveform data, separate doublet waveforms into individual waveforms; perform an analysis of the individual waveforms separated for each doublet; and categorize the doublets based on the analysis of the individual waveforms.

A variety of additional aspects will be set forth in the description that follows. The aspects can relate to individual features and to combination of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawing figures, which form a part of this application, are illustrative of the described technology and are not meant to limit the scope of the disclosure in any manner.

FIG. 1 schematically illustrates an example of a flow cytometer system.

FIG. 2A shows an example of a particle entering an interrogation zone of the flow cytometer in the system of FIG. 1.

FIG. 2B shows an example of the particle passing through a central area of the interrogation zone of FIG. 2A.

FIG. 2C shows an example of the particle exiting the interrogation zone of FIG. 2A.

FIG. 3 illustrates an example of waveform data acquired from the flow cytometer in the system of FIG. 1 plotted with respect to a threshold value.

FIG. 4 schematically illustrates an example of a waveform analysis device of the flow cytometer system of FIG. 1.

FIG. 5 graphically illustrates an example of a doublet waveform detected by the flow cytometer system of FIG. 1.

FIG. 6 schematically illustrates an example of a method of performing a flow cytometry analysis by the flow cytometer system of FIG. 1.

FIG. 7 graphically illustrates another example of a doublet waveform detected by the flow cytometer system of FIG. 1.

FIG. 8 graphically illustrates an example of separating the doublet waveform of FIG. 5 into separate waveforms for each cell of the doublet using an independent component analysis.

FIG. 9 graphically illustrates an example of separating the doublet waveform of FIG. 7 into separate waveforms for each cell of the doublet using an independent component analysis.

FIG. 10 illustrates an exemplary architecture of a computing device that can be used to implement aspects of the present disclosure.

### DETAILED DESCRIPTION

Various embodiments will be described in detail with reference to the drawings, where like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

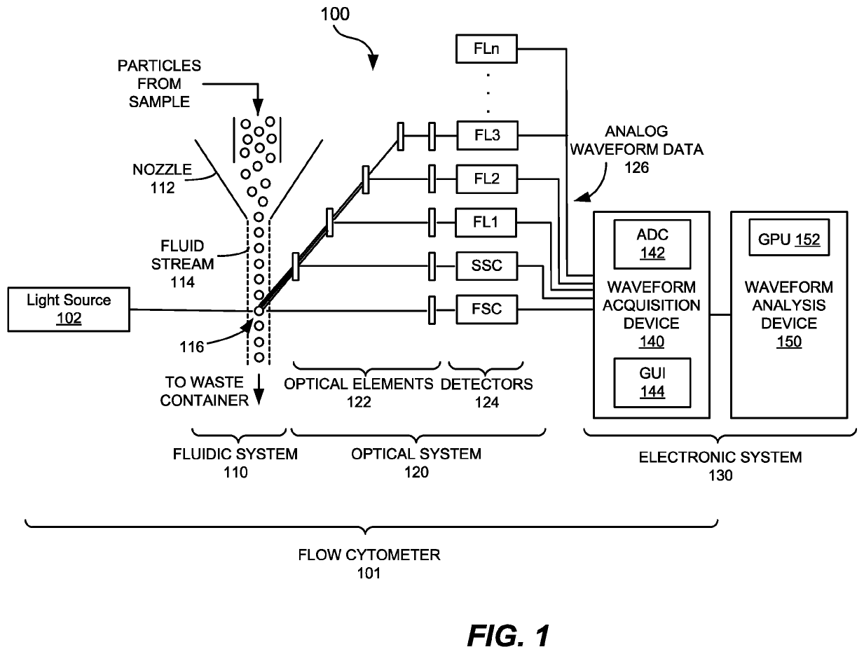

FIG. 1 schematically illustrates an example of a flow cytometer system 100. In some instances, the flow cytometer system 100 can include aspects and features described in U.S. Provisional Patent Application No. 63/410,984, entitled Flow Cytometry Waveform Processing, filed Sep. 28, 2022, U.S. Provisional Patent Application No. 63/481,289, entitled Threshold Logic for Flow Cytometry Waveform Analysis, filed Jan. 24, 2023, and U.S. Provisional Patent Application No. 63/481,293, entitled Control Variable Adjustment for Flow Cytometry Waveform Acquisition, filed Jan. 24, 2023, which are herein incorporated by reference in their entireties.

In general, flow cytometry is a technique for measuring and analyzing properties of particles or cells when flowing in a fluid stream. Data from millions of particles or cells can be collected by the flow cytometer system 100 in a matter of minutes and displayed in a variety of formats. Illustrative example applications of flow cytometry include phenotyping to identify and count specific cell types within a population, analyzing DNA or RNA content within cells, determining presence of antigens on a surface or within cells, and assessing cell health status.

As shown in the illustrative example of FIG. 1, the flow cytometer system 100 generally includes three main component subsystems: a fluidic system 110, an optical system 120, and an electronic system 130. The fluidic system 110 includes a nozzle 112 which receives a sample containing particles or cells suspended in a fluid.

The nozzle 112 creates and ejects a fluid stream 114 of the particles or cells arranged in a single file line. Each particle or cell passes through one or more beams of light produced by a light source 102. The point at which a particle or cell intersects with a light beam is known as an interrogation zone 116. In some examples, the light source 102 includes one or more lasers.

The optical system 120 includes the light source 102, optical elements 122, and detectors 124. At the interrogation zone 116, light from the light source 102 hits a particle or cell in the fluid stream 114 and scatters. The optical elements 122 direct the scattered light toward the detectors 124. The detectors 124 can include a forward scatter (FSC) detector to measure scatter in the path of the light source 102, a side scatter (SSC) detector to measure scatter at a ninety-degree angle relative to the light source 102, and one or more fluorescence detectors (FL1, FL2, FL3 . . . FLn) to measure the emitted fluorescence intensity at different wavelengths of light.

Generally, FSC intensity is proportional to the size or diameter of a particle due to light diffraction around the particle. FSC may therefore be used for the discrimination of particles by size. SSC, on the other hand, is produced from light refracted or reflected by internal structures of the particle and may therefore provide information about the internal complexity or granularity of the particle. By adding fluorescent labelling to a sample, different fluorescent signals/channels (e.g., green, orange, and red) can be analyzed for functional characteristics of a cell. For example, since T-cells present CD3 binding sites, a sample containing T-cells may be “stained” with anti-CD3 antibodies conjugated with a fluorescent molecule. As these cells pass through the interrogation zone 116, the light from the source light excites the fluorescent tag, or fluorochrome, to emit photons at a wavelength detectable by a fluorescence detector. The detectors 124 may therefore simultaneously measure several parameters and enable categorization of particles by their function based on detected wavelengths of light.

The electronic system 130 includes a waveform acquisition device 140 and a waveform analysis device 150. The waveform acquisition device 140 is communicatively coupled with the detectors 124 to receive analog waveform data 126 generated by the detectors 124. The waveform acquisition device 140 includes an analog-to-digital converter (ADC) 142 that is configured to digitize the analog waveform data 126 received from the detectors 124.

The waveform analysis device 150 is configured to receive the digital waveform data and display it for a user of the flow cytometer system 100. In some embodiments, the waveform analysis device 150 comprises a computing device communicatively coupled with a flow cytometer 101, such as over a network. The flow cytometer 101 may include the fluidic system 110, optical system 120, and waveform acquisition device 140. In other embodiments, the waveform analysis device 150 is integrated with the flow cytometer 101.

Current flow cytometers use a field-programmable gate array (FPGA) in the waveform acquisition device to obtain information about individual particles passing through the light beam. The waveform acquisition device uses a single threshold value to determine when the output of the detectors begins conversion from analog to digital. Only a single threshold value can be used for a single run of a sample through the flow cytometer. The threshold value is a constant value and may be referred to as a voltage threshold value. As such, if or when a detector outputs a voltage value that crosses the threshold, digitization begins, and the digital value is sent to the FPGA. As waveform data is digitized, the FPGA computes the height, width, and area of each pulse. Besides the height, width, and area of each pulse, other data relating to the waveform, including data not exceeding the voltage threshold value, is not captured, stored, or otherwise available for analysis. Additionally, if a user wishes to adjust the threshold value, the experiment must be re-run with the new threshold value, incurring costs in resources and time.

To address the above issues, the flow cytometer system 100 is improved with a graphics processing unit (GPU) 152. In the example illustrated in FIG. 1, the GPU 152 is shown included as a component of the waveform analysis device 150. The GPU 152 processes a continuous digital stream generated by the waveform acquisition device 140. The digital stream is continuous in that the waveform acquisition device 140 does not threshold the waveform data produced by the detectors 124. In contrast to current flow cytometry techniques, during an experiment, the waveform acquisition device 140 continuously digitizes the analog waveform data 126 at a high rate (e.g., 1 GHz) without thresholding. In some instances, the GPU 152 enables removal of the FPGA from the waveform acquisition device 140.

Given the foregoing description, the waveform analysis device 150 receives a digitized version of the waveform data with increased data points, and the waveform data for an experiment is displayed and available in its entirety for processing by the GPU 152. In addition to having the capability of processing a large stream or file of waveform data, the GPU 152 enables thresholding the waveform at the post-processing step as opposed to the waveform acquisition step. This in turn provides several technical benefits including the ability to dynamically adjust thresholds and update graphical plots in real-time without re-running an experiment. The GPU 152 may also measure and extract biologically relevant information present in the waveform data beyond the three parameters of height, width, and area. Further details of operation and advantages are discussed below.

The flow cytometer system 100 includes elements which are shown and described for purposes of discussion, and it will be appreciated that numerous variations in components and functions are possible. The optical elements 122 may include a series of filters, dichroic mirrors, and/or beam splitters to select out different wavelengths of light and provide the wavelength to the appropriate detector. The detectors 124 may comprise, for example, photomultiplier tubes (PMTs) or avalanche photodiodes (APDs) or single photon counting devices.

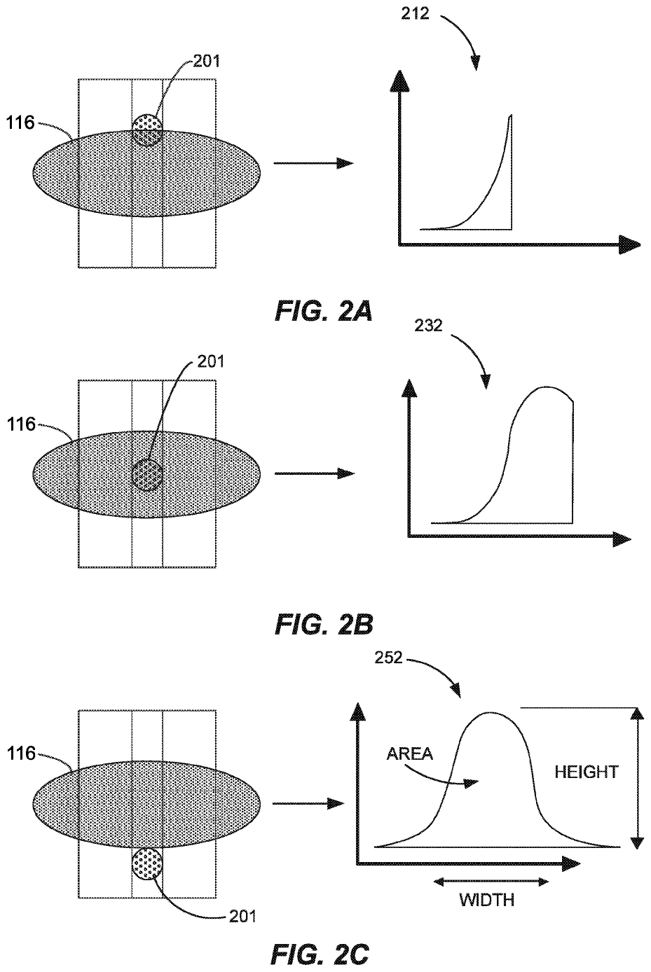

FIGS. 2A-2C illustrate examples of waveform data generated by a particle 201 as it passes through the interrogation zone 116. As the particle 201 passes through the interrogation zone 116, a pulse is detected by one or more of the detectors 124.

FIG. 2A shows an example of the particle 201 entering the interrogation zone 116. As the particle 201 starts to intersect with the interrogation zone 116, the particle 201 begins to generate scattered light and fluorescence signals. The detector 124 produces a current or voltage that is proportional to the scattered light and fluorescence signals. The output of the detector 124 begins to rise as shown in plot 212 due to current flowing in the detector 124.

FIG. 2B shows an example of the particle 201 passing through a central area of the interrogation zone 116. As the particle 201 continues to move through the interrogation zone 116, the particle 201 becomes fully illuminated. Since photon density is highest in the central portion of the interrogation zone 116, a maximum amount of optical signal is produced in this example. As shown in plot 232, the current or voltage of the detector 124 peaks when the particle 201 passes through the central area of the interrogation zone 116.

FIG. 2C shows an example of the particle 201 exiting the interrogation zone 116. As the particle 201 exits the interrogation zone 116, the current or voltage output of the detector 124 returns to the baseline. The generation of the pulse shown in plot 252 is called an event. The height of the plot 252 represents the maximum current/voltage output by the detector 124 which can be proportional to the signal intensity and size of the particle, the width of the plot 252 represents the time it took for the particle to pass through the interrogation zone 116, and the area under the plot 252 can represents the signal intensity and size of the particle. Accordingly, the height, width, and area of the plot 252 can be used to characterize the particle.

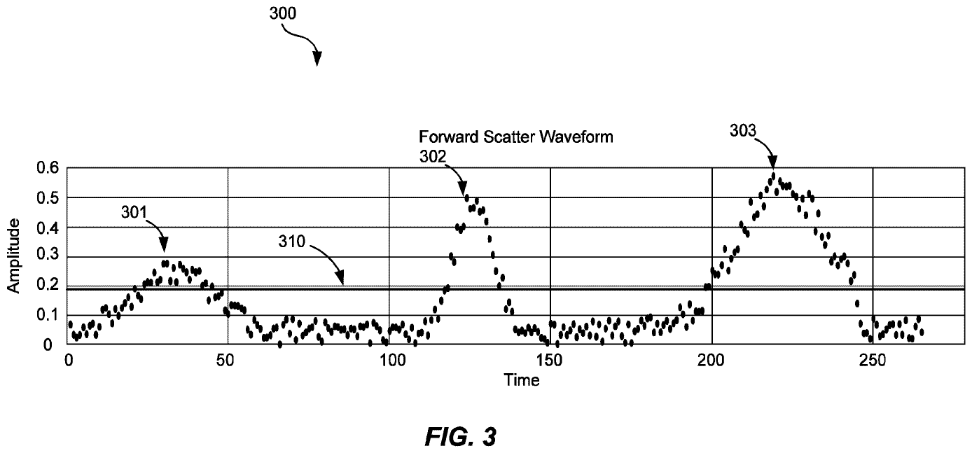

FIG. 3 illustrates an example of waveform data 300 plotted with respect to a threshold value 310. In this illustrative example, the threshold value 310 represents a single constant threshold voltage. As previously described, in traditional polychromatic and spectral flow cytometry, the threshold value 310 is used to specify when the digitization of detector output (e.g., analog waveform data 126) begins. That is, when the waveform data 300 travels above the threshold value 310, the waveform acquisition device begins computing the height, width, and area of each pulse 301-303 that is above the threshold value 310. Waveform data 300 that is below the threshold value 310 is discarded during waveform acquisition in prior techniques.

The problem with the above-described approach is that the threshold value 310 may not be appropriately set for the entire voltage waveform for the purpose of extracting event data. For instance, the threshold value 310 of this example may be set too high to accurately analyze cells generating a pulse similar to the pulse 301 of the waveform data 300. On the other hand, if the threshold value 310 is set too low it may compromise the overall signal-to-noise ratio of the waveform data 300. Additionally, in conventional flow cytometers, the single threshold value must be set prior to data acquisition, irreversibly discarding events of potential relevance.

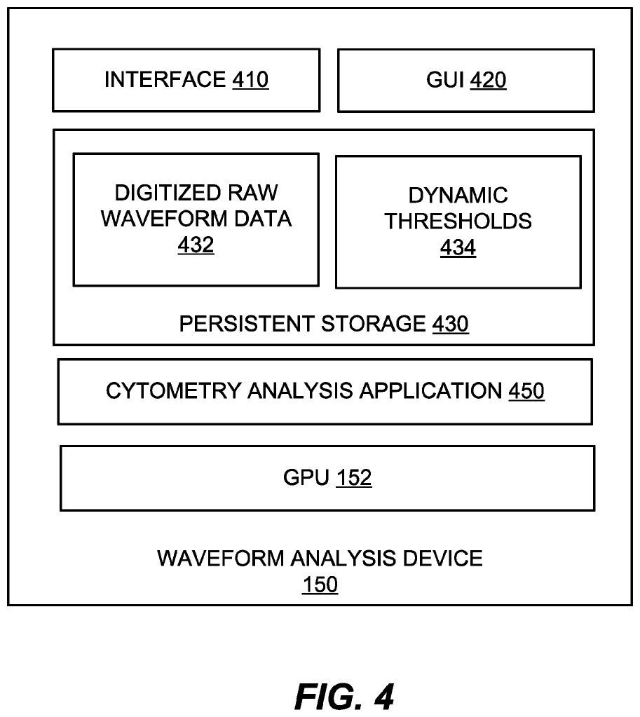

FIG. 4 schematically illustrates an example of the waveform analysis device 150. The waveform analysis device 150 receives, stores, and displays waveform data that has been continuously sampled without having been thresholded upstream at the waveform acquisition device 140. The waveform analysis device 150 includes an interface 410 to receive digitized raw waveform data 432, a persistent storage 430 to store the digitized raw waveform data 432, and can include a graphical user interface (GUI) 420 to display the digitized raw waveform data 432. The persistent storage 430 may also store a plurality of dynamic thresholds 434 that allow for non-linear thresholding and real-time updating and displaying of applied thresholds as further described below. The persistent storage 430 may comprise system memory such as random-access memory (RAM) and/or long-term non-volatile memory such as a hard drive.

The waveform analysis device 150 may further include a cytometry analysis application 450 comprising a software application or a set of related software applications configured to instruct the GPU 152 to process the digitized raw waveform data 432. The cytometry analysis application 450 may execute on one or more processors to provide the functionality described herein in conjunction with the GPU 152 such as receiving user input via the GUI 420. One or more components of the waveform analysis device 150 may reside in a cloud computing application in a network distributed system. In that regard, the waveform analysis device 150 may be any of a variety of computing devices, including, but not limited to, a personal computing device, a server computing device, or a distributed computing device.

Doublets occur when two cells are concatenated together. Typically, doublets are excluded from an analysis in flow cytometry because doublets affect the quality of data such as by causing false positives and/or false negatives to be included in the data. While the following disclosure refers doublets, it is contemplated that the methods and techniques described herein can be similarly applied to other types of n-concatenated cells such as when more than two cells are concatenated together such as triplets, quadruplets, and the like

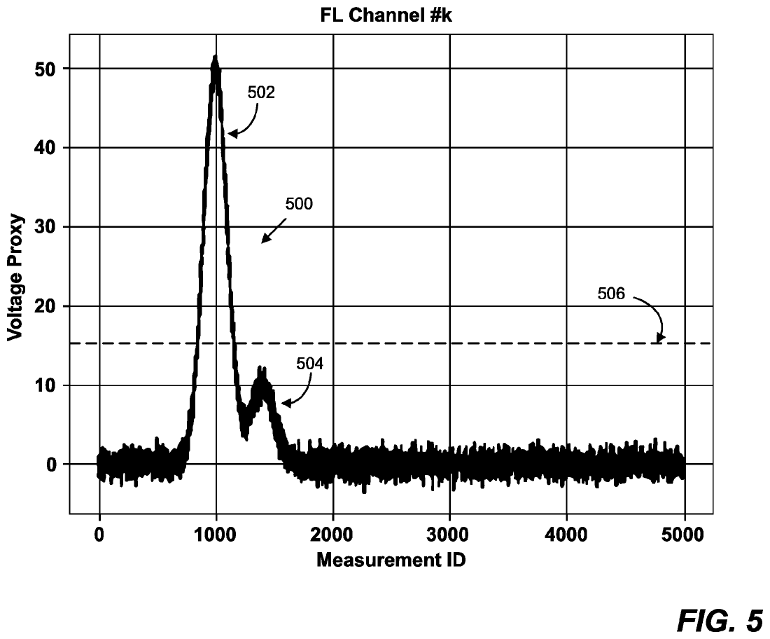

FIG. 5 graphically illustrates an example of a waveform 500 detected by the flow cytometer system 100 that is representative of a doublet. In this example, the waveform 500 is detected by one of the fluorescence channels (i.e., detectors FL1-FLn) of the flow cytometer 101. As shown in FIG. 5, the waveform 500 includes a first peak 502 that is representative of a cell that is positive for a characteristic such as the presence of a fluorochrome. The waveform 500 also includes a second peak 504 that is representative of a cell that is not positive for the characteristic. The presence of the characteristic or lack thereof is indicated by the first peak 502 having a higher fluorescence voltage value than the second peak 504.

In this example, if the waveform 500 is not excluded from a flow cytometry analysis, or is otherwise interpreted or perceived as a singlet, a false positive will be introduced into the dataset because the second cell (i.e., the second peak 504) is negative for said characteristic. Also, if the waveform 500 is excluded from the flow cytometry analysis, relevant information is lost because the first cell (i.e., the first peak 502) is positive for said characteristic. Given the foregoing, it would be advantageous to include the waveform 500 into the flow cytometry analysis without introducing a false positive or false negative in the dataset.

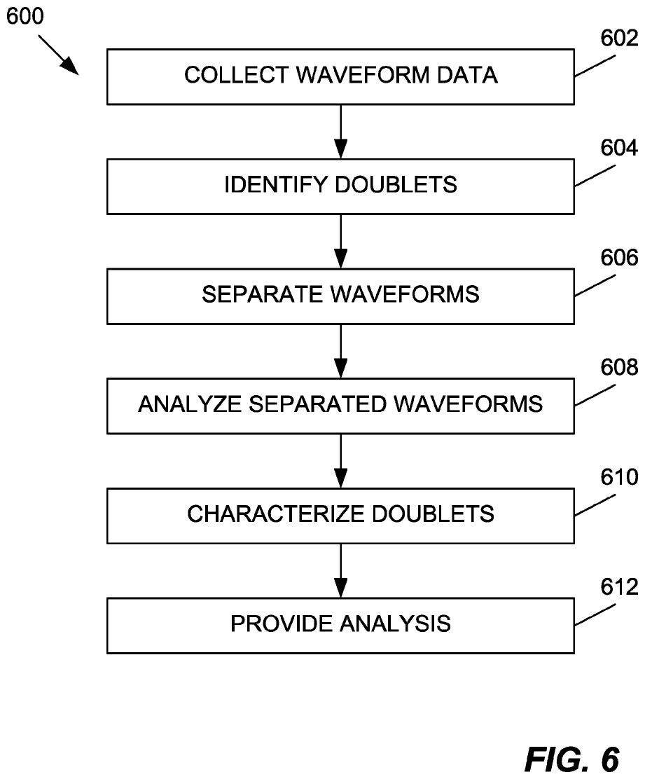

FIG. 6 schematically illustrates an example of a method 600 of performing a flow cytometry analysis by the flow cytometer system 100. As will be described in more detail, the method 600 can improve the accuracy of the flow cytometry analysis by including in the flow cytometry analysis an analysis of doublets which are typically discarded during flow cytometry.

The method 600 includes an operation 602 of collecting waveform data. As described above, the waveform data is collected without thresholding and without discarding doublets such that the waveform data includes all events detected by the detectors 124 of the optical system 120. Collecting the waveform data without thresholding is advantageous over traditional flow cytometry systems that use thresholding because in some instances a doublet can include a concatenated event that is below a threshold such that the doublet is perceived as a singlet. For example, referring to FIG. 5, if a threshold 506 were applied to the waveform 500, the second cell (i.e., the second peak 504) would be undetected because the entirety of the second cell is below the threshold 506 such that the waveform 500 would be characterized as a singlet.

Referring to FIG. 6, the method 600 includes an operation 604 of identifying doublets in waveform data collected in operation 602. The doublets are identified in operation 604 post-acquisition since the waveform data collected in operation 602 includes all events detected by the detectors 124 without thresholding and without discarding doublets.

In operation 604, the doublets can be identified using several different techniques. These techniques can be performed either individually, or in combination with one another to improve the accuracy of the doublet identification in operation 604. The present disclosure is not limited to any of the doublet identification techniques described below, and it is contemplated that new doublet identification techniques may be developed in the future.

In some examples, the doublets are identified in operation 604 by calculating a ratio of an area under a pulse versus a height of the waveform pulse (see FIG. 2C) for front scatter or side scatter radiated light. Doublets will typically have double the area with the same height as singlets due to the shape of the doublets which includes two cells concatenated together.

In some examples, operation 604 includes performing one or more detection algorithms that can include detecting a multimodality of a waveform. For example, in front scatter and side scatter channels, a multimodal waveform with two modes is expected, with a difference between the modes being a function of an amount of overlap. Combined with thresholding and other tunable parameters, when a waveform is multimodal above some threshold and within constraints of other parameters, the waveform is identified as a doublet.

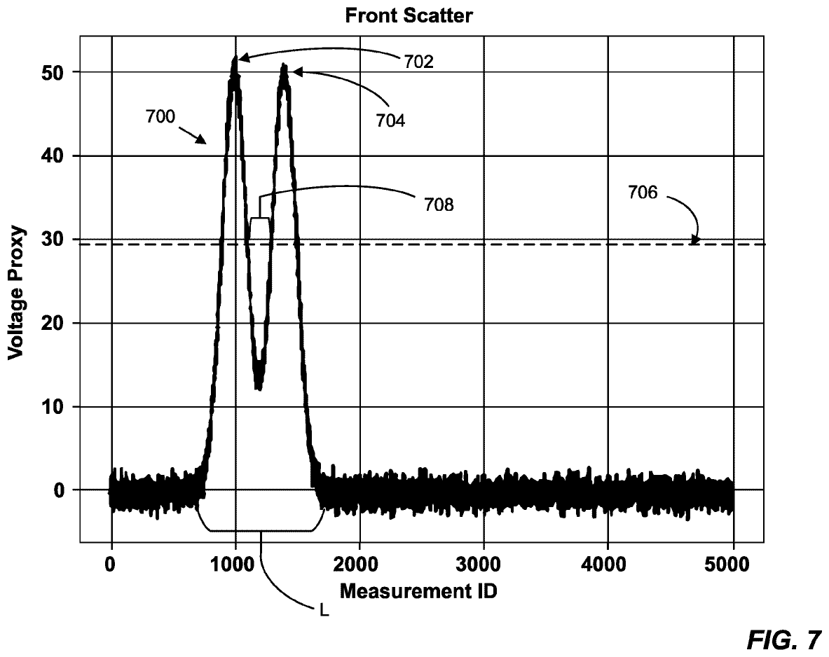

FIG. 7 graphically illustrates another example of a waveform 700 detected by the flow cytometer system 100 that is representative of a doublet. In this example, the waveform 700 is generated from the front scatter channel (FSC) detector 124 of the flow cytometer 101 (see FIG. 1). A similar waveform can be produced from the side scatter channel (SSC) detector 124 of the flow cytometer 101. As shown in FIG. 7, the waveform 700 includes a first peak 702 and a second peak 704. A predetermined threshold 706 is applied to the waveform 700 to measure a separation parameter 708 between the first and second peaks 702, 704. In accordance with the examples described above, the predetermined threshold 706 is applied post-acquisition.

The separation parameter 708 between the first and second peaks 702, 704 is a function of an amount of overlap between two concatenated cells. For example, a larger overlap between two concatenated cells results in a smaller value for the separation parameter 708. In contrast, a smaller overlap between two concatenated cells results in a larger value for the separation parameter 708. Thus, the separation parameter 708 can be used to determine an amount of overlap between two cells that pass through the interrogation zone 116.

The detection algorithm performed in operation 604 identifies doublets by comparing the separation parameter 708 to a threshold distance value. For example, when the separation parameter 708 is less than the threshold distance value, this indicates that two cells substantially overlap one another such that they are concatenated together in a doublet. When the separation parameter 708 is greater than the threshold distance value, this can indicate that the two cells do not overlap one another such that they are not concatenated together, and are thus singlets.

In some examples, a total length L of the waveform 700 is measured. The total length L is then compared to a default threshold, and a doublet is identified based on this comparison. In some further examples, a ratio between the separation parameter 708 and the total length L of the waveform 700 is used to identify whether the waveform 700 is a singlet or doublet.

Operation 604 can further include transforming domain of the waveform data collected in operation 602, which includes time series data. In such examples, the time series data can be transformed into a different domain, such as a frequency domain. Thereafter, a heuristic threshold can be applied to identify doublets. For example, the separation parameter 708 shown in FIG. 7 is a blip in a frequency spectrum because of periodicity. In a singlet waveform, this blip is typically not present. Thus, operation 604 can include identifying the separation parameter 708 and thresholding it (e.g., by comparing it to a threshold distance value) to distinguish doublets from singlets.

In further examples, operation 604 can include performing a supervised classification machine learning algorithm to identify doublets. Supervised learning (SL) is a machine learning technique that uses training data that includes labeled samples, such that each data point contains features (covariates) and an associated label. A supervised learning algorithm analyzes the training data to produce an inferred function, which can be used for mapping new samples.

In further examples, operation 604 can include performing an unsupervised clustering machine learning algorithm to identify doublets. Unsupervised learning is a type of machine learning algorithm that identifies patterns from unlabeled data points. Such techniques can be used to identify a cluster of waveforms that correspond with doublets. As noted above, operation 604 can include combining several of the algorithms described above for identifying doublets.

As further shown in FIG. 6, the method 600 includes an operation 606 of separating the doublet waveforms into individual waveforms. The doublet waveforms are separated in operation 606 post-acquisition since the waveform data collected in operation 602 includes all events detected by the detectors 124 without thresholding and without discarding doublets.

In operation 606, the doublet waveforms can be separated using several different techniques. These techniques can be performed either individually, or in combination with one another to improve the doublet waveform separation in operation 606. The present disclosure is not limited to any of the doublet waveform separation techniques described below, and it is contemplated that new doublet waveform separation techniques may be developed in the future.

In some examples, the doublet waveforms are separated in operation 606 by performing one or more blind source separation algorithms. Blind source separation includes the separation of one or more source signals from a set of mixed signals typically without the aid of information (or with very little information) about the source signals or the mixing process.

At least one example of a blind source separation algorithm that can be performed in operation 606 includes an independent component analysis (ICA) to separate the doublet waveform into separate waveforms for each cell of the doublet. ICA can be especially useful when the waveform of each cell in the doublet is non-Gaussian.

In some examples, a preprocessing step is performed to first identify a doublet, and then the doublet is windowed to a fixed size before performing ICA. For example, ICA can use the time series data collected in operation 602, but the length of the data should ideally be fixed. A window can be applied around the doublets before performing ICA. The window covering the doublets should ideally be the same size for each channel of the flow cytometer system 100 (e.g., the scatter and fluorescence channels). As an illustrative example, when there are k channels and a window is predefined to include 1000 data points, this results in a k×1000 matrix.

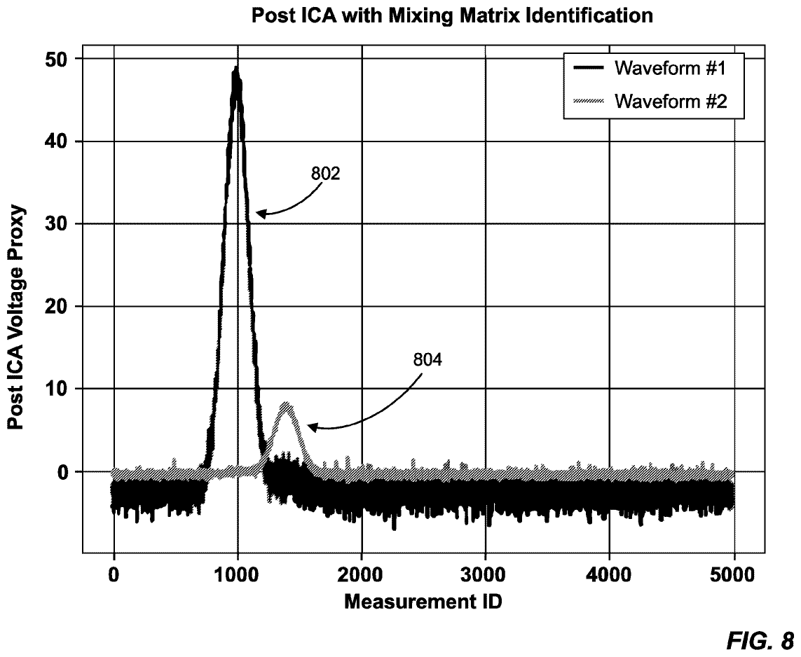

FIG. 8 graphically illustrates an example of separating the doublet waveform of FIG. 5 into separate waveforms for each cell of the doublet. In this example, the doublet waveform is separated into the waveforms for each cell of the doublet using ICA. As shown in FIG. 8, the doublet waveform is separated into a first waveform 802 for the first cell of the doublet, and is separated into a second waveform 804 for the second cell of the doublet.

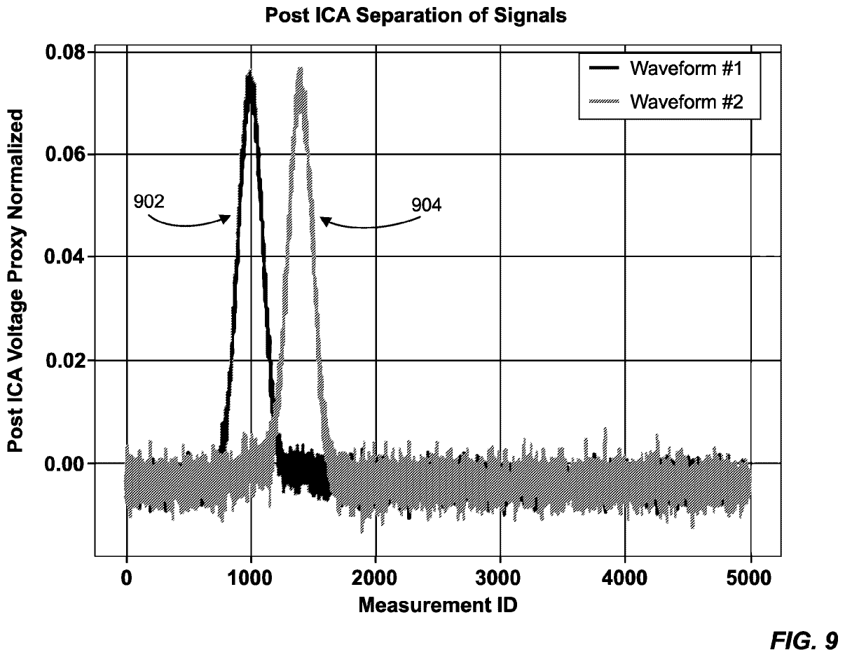

FIG. 9 graphically illustrates an example of separating the doublet waveform of FIG. 7 into separate waveforms for each cell of the doublet. In this example, the doublet waveform is separated into the waveforms for each cell of the doublet using ICA. As shown in FIG. 9, the doublet waveform is separated into a first waveform 902 for the first cell of the doublet, and is separated into a second waveform 904 for the second cell of the doublet.

In further examples, Gaussian mixture models are used in operation 606 to distinguish the separate waveforms for each cell in the doublet. In such examples, the doublet is treated as an unnormalized probability density function. More specifically, the doublet can be characterized as a mixture of two Gaussian waveforms. The modes and variances are determined to identify the constituents of the mixture. Unnormalized Gaussian waveforms are determined for each constituent waveform in the mixture.

Using this technique, it is possible to distinguish the waveforms of the first and second cells in the doublet such as when the first cell is positive for a characteristic (e.g., fluorochrome) and the second cell is negative.

One example of a Gaussian mixture model includes preprocessing (like in the ICA algorithm described above). In such examples, a time series of data is collected for each channel, and the doublet is windowed (e.g., take measurement recording j to measurement j+1000). The value at each measurement point is treated as a weighted number of samples at that point. This can be done for each waveform channel resulting in samples for each measurement point. Expectation maximization or some other types of sampling methods are performed to generate parameters describing each component of the doublet in the Gaussian mixture model.

Another example includes windowing the doublet, and training via backpropagation to identify parameters of a gaussian curve that fit the time series data. This is similar to curve fitting where there are a fixed number of points, and a parametric form of the curve is known.

In further examples, heuristics along with forecasting is performed in operation 606 to separately identify the waveforms for each cell in the doublet. This technique can include extracting information from the beginning and tail of the doublet waveform to determine characteristics for the waveforms of each cell in the doublet. Using this information, it is possible to predict each waveform separately starting from the front and tail of the waveforms.

As an illustrative example, the doublet is windowed to have a fixed amount (and the same amount) of data points for each channel. A model can be trained on supervised data of non-doublets to predict a remaining portion of a waveform given some initial percentage. Example models can include neural networks, probabilistic time series models, and the like. The trained model can be used to predict individual waveforms of the concatenated cells in the doublet.

In further examples, clustering techniques can be performed in operation 606 to separately identify the waveforms for each cell in the doublet. Such techniques can include maintaining a database of waveforms, and separating and/or predicting the separate waveforms for each cell via a minimization scheme using the waveforms in the database.

The method 600 further includes an operation 608 of analyzing the waveforms separated in operation 606 for each cell in a doublet. For example, operation 608 can include analyzing each waveform in the doublet as if it were a singlet waveform. In this manner, the first and second cells of each doublet are each separately analyzed.

Next, the method 600 includes an operation 610 of characterizing the doublets based on the analysis of each separate waveform in each doublet. Operation 610 can include characterizing the doublets based on whether each separate waveform includes a characteristic or not. As an illustrative example, operation 610 can include characterizing or classifying a doublet based on whether both cells in the doublet include the characteristic, whether one cell in the doublet includes the characteristic and the other cell in the doublet does not, or whether neither cell in the doublet includes the characteristic.

In some examples, the method 600 can include an operation 612 of providing an analysis of the waveform data collected in operation 602 based at least in part on the characterizations of the doublets done in operation 610. In some examples, operation 612 can include displaying the analysis on the GUI 420 of the waveform analysis device 150.

In some examples, operation 612 includes presenting a classification of the doublets independently of the singlets. In such examples, a user of the flow cytometer system 100 can view an analysis specific to the doublets. Such analysis can include information related to a magnitude of the doublets that have at least one cell with a characteristic, which have at least one cell that is missing the characteristic, which have both cells with the characteristic, and/or that have both cells missing the characteristic. In this manner, relevant information specific to the doublets identified in the fluid stream 114 is presented to the user of the flow cytometer system 100. As discussed above, traditional flow cytometers typically discard doublets during waveform acquisition such that this information is lost and never made available.

In further examples, operation 612 includes presenting a classification of the doublets together with the singlets. As shown in the example of FIG. 8, the first waveform 802 can be included in the classification as a positive event, and the second waveform 804 can be included as a negative event. In this manner, false positives are excluded from the classification such that this feature provides a more accurate analysis of the sample overall.

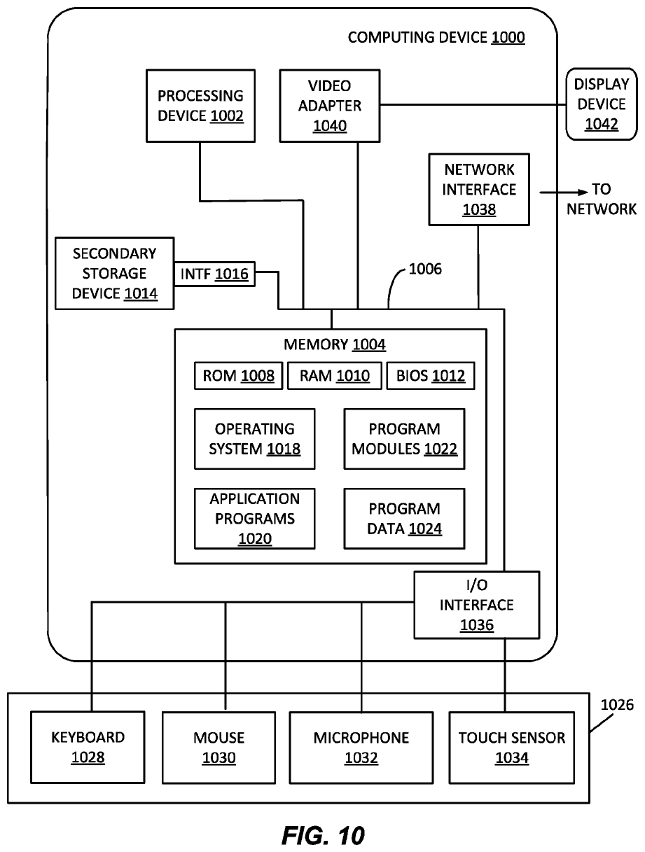

FIG. 10 illustrates an exemplary architecture of a computing device 1000 that can be used to implement aspects of the present disclosure, including the waveform analysis device 150. The computing device illustrated in FIG. 10 can be used to execute the operating system, application programs, and software modules (including the software engines) described herein.

The computing device 1000 includes at least one processing device 1002, such as a central processing unit (CPU). In this example, the computing device 1000 also includes a system memory 1004, and a system bus 1006 that couples various system components including the system memory 1004 to the at least one processing device 1002. The system bus 1006 is one of any number of types of bus structures including a memory bus, or memory controller; a peripheral bus; and a local bus using any of a variety of bus architectures.

The system memory 1004 includes read only memory (ROM) 1008 and random-access memory (RAM) 1010. A basic input/output system 1012 containing the basic routines that act to transfer information within computing device 1000, such as during start up, is typically stored in the read only memory 1008. In some examples, the system memory 1004 has a large memory capacity, such as equal to or greater than one Terabyte of RAM. The RAM can be used to load and subsequently analyze the waveform data (e.g., the raw waveform data, such as stored in a raw waveform data file, which can include digitalized waveform data).

The computing device 1000 also includes a secondary storage device 1014 in some embodiments, such as a hard disk drive, for storing digital data. The secondary storage device 1014 is connected to the system bus 1006 by a secondary storage interface 1016. In some examples, the secondary storage devices 1014 and their associated computer readable media provide nonvolatile storage of computer readable instructions (including application programs and program modules), data structures, and other data for the computing device 1000.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

Several program modules can be stored in secondary storage device 1014 or system memory 1004, including an operating system 1018, one or more application programs 1020, other program modules 1022 (e.g., software engines described herein), and program data 1024. The computing device 1000 can utilize any suitable operating system, such as Microsoft Windows™, Google Chrome™, Apple OS, and any other operating system suitable for a computing device.

In some examples, a user provides inputs to the computing device 1000 through one or more input devices 1026. Examples of input devices 1026 include a keyboard 1028, mouse 1030, microphone 1032, and touch sensor 1034 (such as a touchpad or touch sensitive display). Additional examples include additional types of input devices 1026, or fewer types of input devices 1026. The input devices 1026 are connected to the at least one processing device 1002 through an input/output interface 1036 coupled to the system bus 1006. The input/output interface 1036 can include any number of input/output interfaces, such as a parallel port, serial port, game port, or a universal serial bus. Wireless coupling between input devices 1026 and the input/output interface 1036 is possible as well, such as through infrared, BLUETOOTH®, 802.11a/b/g/n, cellular, or other radio frequency communication systems in some possible embodiments.

In this example embodiment, a display device 1042, such as a monitor, liquid crystal display device, projector, or touch sensitive display device, is also connected to the system bus 1006 via a video adapter 1040. In addition to the display device 1042, the computing device 1000 can include various other peripheral devices (not shown), such as speakers or a printer.

When used in a local area networking environment or a wide area networking environment (such as the Internet), the computing device 1000 is typically connected to a network such as through a network interface 1038, such as an Ethernet interface. Other possible embodiments use other communication devices. For example, some embodiments of the computing device 1000 include a modem for communicating across the network.

The computing device 1000 typically includes at least some form of computer readable media. Computer readable media includes any available media that can be accessed by the computing device 1000. By way of example, computer readable media include computer readable storage media and computer readable communication media.

Computer readable storage media includes volatile and nonvolatile, removable, and non-removable media implemented in any device configured to store information such as computer readable instructions, data structures, program modules or other data. Computer readable storage media includes, but is not limited to, random access memory, read only memory, electrically erasable programmable read only memory, flash memory, compact disc read only memory, digital versatile disks or other optical storage, magnetic cassettes, magnetic tape, magnetic disk storage or other magnetic storage devices, or any other medium that can be used to store the desired information and that can be accessed by the computing device. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device 1000 is also an example of programmable electronics, which may include one or more such computing devices, and when multiple computing devices are included, such computing devices can be coupled together with a suitable data communication network to collectively perform the various functions, methods, or operations disclosed herein.

Although specific embodiments are described herein, the scope of the disclosure is not limited to those specific embodiments. The scope of the disclosure is defined by the following claims and any equivalents thereof.

1. A flow cytometry system for analyzing a fluid stream of particles, the flow cytometry system comprising:
a light source for emitting a light beam toward an interrogation zone;
an optical system including detectors for detecting radiated light from particles passing through the light beam in the interrogation zone; and
a processing circuitry having non-transitory computer readable storage media storing instructions which, when executed by the processing circuity, cause the processing circuitry to:
collect waveform data without thresholding the radiated light detected from the particles passing through the light beam in the interrogation zone;
identify doublets from the waveform data;
for each doublet identified from the waveform data, separate doublet waveforms into individual waveforms;
perform an analysis of the individual waveforms separated for each doublet; and
categorize the doublets based on the analysis of the individual waveforms.

2. The flow cytometry system of claim 1, wherein the non-transitory computer readable storage media store additional instructions which, when executed by the processing circuitry, further cause the processing circuitry to:
categorize the doublets independently of singlets in the waveform data.

3. The flow cytometry system of claim 1, wherein the non-transitory computer readable storage media store additional instructions which, when executed by the processing circuitry, further cause the processing circuitry to:
categorize the doublets together with singlets in the waveform data.

4. The flow cytometry system as in claim 1, wherein the doublets are categorized based on whether a characteristic is detected in both cells, the characteristic is detected in one cell but not in another cell, or the characteristic is missing in both cells.

5. The flow cytometry system according to claim 1, wherein the doublets are identified by calculating a ratio of an area versus a height of the doublet waveforms.

6. The flow cytometry system according to claim 1, wherein the doublets are identified by a detection algorithm that determines whether the individual waveforms are within a predetermined distance threshold.

7. The flow cytometry system according to claim 1, wherein the doublets are identified by one or more machine learning algorithms.

8. The flow cytometry system according to claim 1, wherein the doublet waveforms are separated into the individual waveforms by performing an independent component analysis.

9. A method of analyzing particles flowing through a flow cytometer, the method comprising:
collecting waveform data without thresholding radiated light detected from the particles passing through a light beam in an interrogation zone;
identifying doublets from the waveform data;
for each doublet identified from the waveform data, separating doublet waveforms into individual waveforms;
analyzing the individual waveforms separated for each doublet; and
categorizing the doublets based on the analysis of the individual waveforms.

10. The method of claim 9, further comprising:
categorizing the doublets independently of singlets in the waveform data, or categorizing the doublets together with singlets in the waveform data.

11. The method as in claim 9, further comprising:
categorizing the doublets based on whether a characteristic is detected in both cells, the characteristic is detected in one cell but not in another cell, or the characteristic is missing in both cells.

12. The method as in claim 9, wherein the doublets are identified by calculating a ratio of an area versus a height of the doublet waveforms.

13. The method as in claim 9, wherein the doublets are identified by a detection algorithm that determines whether the individual waveforms are within a predetermined distance threshold.

14. The method as in claim 9, wherein the doublets are identified by one or more machine learning algorithms.

15. The method as in claim 9, wherein the doublet waveforms are separated into the individual waveforms by performing an independent component analysis.

16. A non-transitory computer readable medium comprising program instructions, which when executed by a processor, cause the processor to:
collect waveform data without thresholding radiated light detected from particles passing through a light beam in an interrogation zone;
identify doublets from the waveform data;
for each doublet identified from the waveform data, separate doublet waveforms into individual waveforms;
perform an analysis of the individual waveforms separated for each doublet; and
categorize the doublets based on the analysis of the individual waveforms.

17. The non-transitory computer readable medium of claim 16, further comprising additional program instructions, which when executed by a processor, further cause the processor to:
categorize the doublets independently of singlets in the waveform data, or categorize the doublets together with singlets in the waveform data.

18. The non-transitory computer readable medium as in claim 16 wherein the doublets are categorized based on whether a characteristic is detected in both cells, the characteristic is detected in one cell but not in another cell, or the characteristic is missing in both cells.

19. The non-transitory computer readable medium as in claim 16, wherein the doublets are identified by calculating a ratio of an area versus a height of the doublet waveforms.

20. The non-transitory computer readable medium of claim 16, wherein the doublets are identified by a detection algorithm that determines whether the individual waveforms are within a predetermined distance threshold, or by one or more machine learning algorithms; and
wherein the doublet waveforms are separated into the individual waveforms by performing an independent component analysis.
